(19) United States
(12) Patent Application Publication
(10) Pub. No.: US 2014/0147818 A1
(43) Pub. Date: May 29, 2014

(54) Backflow Preventer Training Software Program

(71) Applicant: Ronald Martin Hyatt, Bakersfield, CA (US)

(72) Inventor: Ronald Martin Hyatt, Bakersfield, CA (US)

(21) Appl. No.: 13/684,757

(22) Filed: Nov. 26, 2012

(51) Int. Cl. G09B 5/00

(52) U.S. Cl. CPC G09B 5/00
USPC 434/219

(57) ABSTRACT

It is a software program; the technical disclosures of the invention are set forth in the software program attached to this non-provisional patent application and titled

I claim priority to my Provisional Application filed on 23 Feb. 2012 (Application No. 61/602,486) as the priority date for this Non-Provisional Application.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Computer Program (titled “BackFlowSimCode”) filed via EFS-Web along with this Specification.

### BACKGROUND OF THE INVENTION

This invention pertains to the backflow prevention industry. Currently, all backflow prevention testing and certification must be performed in a wet-lab with a working physical mock-up of a backflow preventer. Moreover, the trainer and trainees are required to be physically present in the same wet-lab.

### BRIEF SUMMARY OF THE INVENTION

This invention eliminates the need for a wet-lab for training, testing and certification as well as the requirement that the trainees be physically present in a wet-lab classroom with the trainer. This invention allows the trainer to conduct virtual training via the internet with the trainees located offsite at their personal computers. There is no wet-lab required as all of the functions of a working physical mock-up of a backflow preventer are replicated in the software program's interactive three-dimensional display. The virtual backflow preventer is controlled and manipulated by the trainer; the trainees respond to various scenarios initiated by the trainer who then monitors the trainees' responses.

### BRIEF DESCRIPTION OF THE SEVERAL VIEWS OF THE DRAWING

Not Applicable

### DETAILED DESCRIPTION OF THE INVENTION

This invention is a new software program designed to facilitate the training of students in the testing of backflow prevention assemblies. The trainer and students can virtually operate a wet-lab simulator using a computer keyboard and mouse. Prior to this invention, the trainer and students were required to be physically present in a wet-lab setting.

1. What I claim as my invention is a software program that replicates the functions of backflow prevention assemblies in a wet-lab setting.
